(19) United States
(12) Patent Application Publication
(10) Pub. No.: US 2026/0028054 A1
(43) Pub. Date: Jan. 29, 2026

(54) RAIL VEHICLE AND LOW-VACUUM RAIL VEHICLE SYSTEM

(71) Applicant: CRRC QINGDAO SIFANG CO., LTD., Shandong (CN)

(72) Inventors: Dawei CHEN, Shandong (CN); Yongxia LAN, Shandong (CN); Yue LIU, Shandong (CN); Xiaotao LU, Shandong (CN); Qi ZHANG, Shandong (CN)

(21) Appl. No.: 19/110,357

(22) PCT Filed: Sep. 25, 2023
(86) PCT No.: PCT/CN2023/121024

§ 371 Date: Mar. 10, 2025

(30) Foreign Application Priority Data
Apr. 18, 2023 (CN) 202310415147.6

(51) Int. Cl. B61D 27/00; B61B 13/10

(52) U.S. Cl. CPC B61D 27/0009; B61B 13/10; B61D 27/0018

(57) ABSTRACT

A rail vehicle and a low-vacuum rail vehicle system. The rail vehicle comprises: a ram air inlet, the ram air inlet being provided outside a carriage; a compressor, an air inlet of the compressor being communicated with the ram air inlet; a heat exchanger, a hot-side inlet of the heat exchanger being communicated with an air outlet of the compressor), a hot-side outlet of the heat exchanger being communicated with the inner space of the carriage, and a cold side of the heat exchanger being provided with a refrigerant for heat exchange; and an exhaust valve, a first end of the exhaust valve being provided on the inner side of the carriage, and a second end of the exhaust valve being provided on the outer side of the carriage.

### CROSS-REFERENCE TO RELATED APPLICATION

The present application claims priority to Chinese application No. 202310415147.6 filed on Apr. 18, 2023, entitled “Rail Vehicle and Low-vacuum Rail Vehicle System”, which is hereby incorporated by reference in its entirety.

### FIELD

The present application relates to the field of rail vehicles, and in particular, to a rail vehicle and a low-vacuum rail vehicle system.

### BACKGROUND

With the continuous development of technologies of high-speed rail, a future high-speed rail vehicle system has put forward higher requirements for higher speed, lower noise and more energy saving, which is also a future development direction of high-speed rail transportation.

Currently, an operating speed of a high-speed railway has reached 350 km/h. Further increasing the operating speed will cause a sharp increase in atmospheric resistance, wheel-rail resistance and noise. Therefore, development of a low-vacuum rail magnetic levitation high-speed rail vehicle transportation system may solve the above problems.

A high-speed rail vehicle operates in a low-vacuum rail, and it is necessary to solve a problem of pressure regulation in a carriage, otherwise the safety and comfort of passengers cannot be guaranteed. Simultaneously, when a low-vacuum rail vehicle system fails, it is necessary to provide emergency live-saving for passengers to ensure that the passengers are evacuated from the low-vacuum rail in time and to ensure passenger safety.

The information disclosed in this background section is only intended to deepen the understanding of the overall background technology of the present application, and should not be regarded as an acknowledgment or any form of implication that the information constitutes prior art known to those skilled in the art.

### SUMMARY

In response to problems in the related art, the present application provides a rail vehicle and a low-vacuum rail vehicle system.

The present application provides a rail vehicle, including:
a ram air inlet, provided outside a carriage;
an air compressor, where an air inlet of the air compressor communicates with the ram air inlet;
a heat exchanger, where a hot side inlet of the heat exchanger communicates with an air outlet of the air compressor, a hot side outlet of the heat exchanger communicates with a space inside the carriage, and a cold side of the heat exchanger is provided with a refrigerant for heat exchange; and
an exhaust valve, where a first end of the exhaust valve is provided at an inner side of the carriage, and a second end of the exhaust valve is provided at an outer side of the carriage.

In an embodiment, the heat exchanger includes:
a ram air cooling heat exchanger, where a hot side inlet of the ram air cooling heat exchanger communicates with the air outlet of the air compressor, a hot side outlet of the ram air cooling heat exchanger communicates with the space inside the carriage, a cold side inlet of the ram air cooling heat exchanger communicates with the ram air inlet, and a cold side outlet of the ram air cooling heat exchanger communicates with an outside of the carriage.

In an embodiment, the rail vehicle further includes:
a carriage pressure-regulated re-cooling pipeline, where an air inlet of the carriage pressure-regulated re-cooling pipeline communicates with an inside of the carriage;
the heat exchanger further includes:
a re-cooling heat exchanger, where a hot side inlet of the re-cooling heat exchanger communicates with the hot side outlet of the ram air cooling heat exchanger, a hot side outlet of the re-cooling heat exchanger communicates with the space inside the carriage, a cold side inlet of the re-cooling heat exchanger communicates with an air outlet of the carriage pressure-regulated re-cooling pipeline, and a cold side outlet of the re-cooling heat exchanger communicates with the first end of the exhaust valve.

In an embodiment, the rail vehicle further includes:
a ram air cooling fan, where an air inlet of the ram air cooling fan communicates with the ram air inlet, and an air outlet of the ram air cooling fan communicates with the cold side inlet of the ram air cooling heat exchanger.

In an embodiment, the ram air inlet is rotatable to at least forward driving and backward driving directions of the rail vehicle;
the rail vehicle further includes:
a ram air inlet reversing mechanism, where the ram air inlet reversing mechanism is mechanically connected to the ram air inlet.

In an embodiment, the rail vehicle further includes:
an intra-carriage pressure sensor, where the intra-carriage pressure sensor is communicatively connected to the exhaust valve.

In an embodiment, the rail vehicle further includes:
an oxygen generator, where the oxygen generator is communicatively connected to the intra-carriage pressure sensor.

The present application further provides a low-vacuum rail vehicle system for operating a rail vehicle, where the low-vacuum rail vehicle system includes:
a low-vacuum rail, where the low-vacuum rail is provided with multiple sets of seal doors capable of sealing multiple predetermined sections of the low-vacuum rail, the low-vacuum rail is provided with a pressure recovery air inlet, the pressure recovery air inlet is provided with a pressure recovery intake valve, and the low-vacuum rail is provided with an intra-rail pressure sensor; and
a control center, where the control center is communicatively connected to the intra-rail pressure sensor, the seal doors, and the pressure recovery intake valve;
where the control center monitors a pressure signal of the intra-rail pressure sensor, when a scene where personnel need to be evacuated occurs in the rail vehicle, the control center transmits a door-closing control signal to the seal doors on both sides of a section where the rail vehicle is located, and the control center transmits an intake control signal to the pressure recovery intake valve until the pressure signal reaches a predetermined threshold.

In an embodiment, the low-vacuum rail further includes:
a vacuum system exhaust port and a vacuum system;
where the control center is connected to the vacuum system, and the control center transmits a shutdown control signal to the vacuum system when the pressure signal is lower than the predetermined threshold.

In an embodiment, the system further includes:
an emergency rescue passage;
where the low-vacuum rail is provided with an emergency rescue door, and the emergency rescue door is used for separating the emergency rescue passage from the low-vacuum rail.

In the rail vehicle and the low-vacuum rail vehicle system provided by the present application, by combining pressurized air supply of ram air and exhaust of the exhaust valve, a pressure in the low-vacuum rail high-speed rail vehicle may be regulated, problems of pressure reduction caused by the low-vacuum environment of the high-speed rail vehicle, pressure increase caused by air conditioning intake and ventilation, etc. are solved and the pressure in the high-speed rail vehicle meets safety and health requirements of passengers.

### BRIEF DESCRIPTION OF THE DRAWINGS

To illustrate solutions disclosed in the embodiments of the present application or the related art more clearly, drawings needed in the descriptions of the embodiments or the related art will be briefly described below. The drawings in the following description are only some of the embodiments of the present application, and other drawings may be obtained based on these drawings without any creative effort for those skilled in the art.

FIG. 1 is a schematic structural diagram of a rail vehicle according to an embodiment of the present application; and

FIG. 2 is a schematic structural diagram of a high-speed rail vehicle system containing a low-vacuum rail according to an embodiment of the present application.

### REFERENCE NUMERALS

1: carriage; 2: ram air forward inlet; 3: ram air inlet reversing mechanism; 4: ram air backward inlet; 5: electric air compressor; 6: high-speed motor for electric air compressor; 7: ram air cooling fan; 8: ram air cooling heat exchanger; 9: cooling ram air exhaust pipeline; 10: exhaust valve; 11: re-cooling heat exchanger; 12: pressure-regulated air flow distribution pipeline; 13: carriage pressure-regulated re-cooling pipeline; 14: oxygen generator; 15: oxygen mask distribution pipeline; 16: intra-carriage pressure sensor; 17: intra-rail pressure sensor; 18: front seal door; 19: front seal door actuator; 20: rear seal door; 21: rear seal door actuator; 22: vacuum system; 23: vacuum system exhaust port; 24: pressure recovery intake valve; 25: pressure recovery air inlet; 26: emergency rescue door; 27: low-vacuum rail; 28: control center; 29: ram air inlet; 30: air compressor; 31: heat exchanger.

### DETAILED DESCRIPTION

Advantages of the present application are further described below in conjunction with the accompanying drawings and specific embodiments.

Exemplary embodiments will be described in detail here, and examples thereof are shown in the accompanying drawings. When the drawings are described below, unless otherwise indicated, the same numbers in different drawings represent the same or similar elements. The embodiments described in the following exemplary embodiments do not represent all embodiments consistent with the present application. Instead, they are only examples of devices and methods consistent with some aspects of the present application as detailed in the appended claims.

The terms used in the present application are for the purpose of describing specific embodiments only and are not intended to limit the present application. Singular forms “one”, “said” and “the” used in present application and the appended claims are further intended to include plural forms unless the context clearly indicates otherwise. It should also be understood that the term “and/or” used herein refers to and includes any or all possible combinations of one or more associated listed items.

It should be understood that although the terms first, second, third, etc. may be used in present application to describe various pieces of information, these pieces of information should not be limited to these terms. These terms are only used to distinguish the same type of information from each other. For example, without departing from the scope of present application, first information may also be referred to as second information, and similarly, the second information may also be referred to as the first information. Depending on the context, the word “if” as used herein may be interpreted as “at the time of” or “when” or “in response to determining”.

In the description of the present application, it should be understood that the orientation or positional relationships indicated by terms such as “longitudinal,” “lateral,” “upper,” “lower,” “front,” “rear,” “left,” “right,” “vertical,” “horizontal,” “top”, “bottom,” “inside,” “outside,” etc. are based on the orientation or positional relationship shown in the drawings, and are merely for the convenience of describing the present application and simplifying the description, rather than indicating or implying that the device or component stated must have a particular orientation, is constructed and operated in a particular orientation, and thus is not to be construed as limiting the present application.

In the description of the present application, unless otherwise specified and limited, it should be noted that the terms “mounted,” “connected with” and “connected to” should be understood in a broad sense. For example, it may be mechanically connected or electrically connection, or it may be communicated with inside of two elements, it may be directly connected, or it may be indirectly connected through an intermediate medium. For those skilled in the art, the specific meanings of the above terms may be understood based on specific circumstances.

In the subsequent description, the use of suffixes such as “module”, “member” or “unit” used to represent components is only to facilitate the description of the present application, and the suffixes themselves have no specific meaning. Therefore, “module” and “member” may be used interchangeably.

A rail vehicle provided by embodiments of the present application is described in detail below through specific embodiments and their application scenarios in conjunction with the accompanying drawings.

It should be noted that since a high-speed rail vehicle operates in a low-vacuum tube, it is necessary to regulate the pressure in the rail vehicle. Simultaneously, emergency live-saving is required when the system fails. Therefore, in the embodiments of the present application, a pressure in the rail vehicle is regulated by using pressurized air supply of ram air and exhaust of the exhaust valve to meet health requirement of passengers. The emergency live-saving requirement of passengers is met through emergency oxygen supply in the rail vehicle and emergency pressure recovery in the low-vacuum rail.

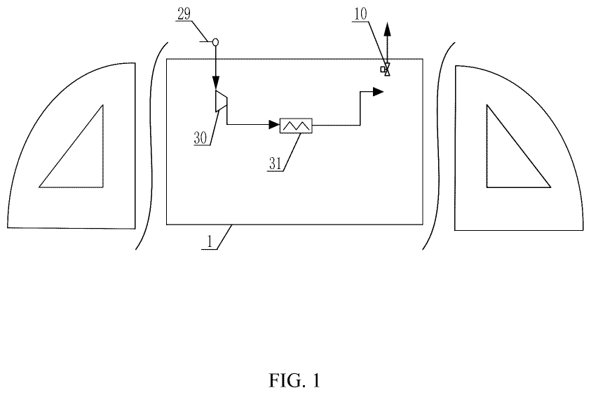

FIG. 1 is a schematic structural diagram of a rail vehicle according to an embodiment of the present application. As shown in FIG. 1, the present application provides a rail vehicle, including: a ram air inlet 29 provided outside a carriage 1; an air compressor 30, where an air inlet of the air compressor 30 communicates with the ram air inlet 29; a heat exchanger 31, where a hot side inlet of the heat exchanger 31 communicates with an air outlet of the air compressor 30, a hot side outlet of the heat exchanger 31 communicates with a space inside the carriage 1, and a cold side of the heat exchanger 31 is provided with a refrigerant for heat exchange; and an exhaust valve 10, where a first end of the exhaust valve 10 is provided at an inner side of the carriage 1, and a second end of the exhaust valve is provided at an outer side of the carriage.

In the present embodiment, by combining pressurized air supply of ram air and exhaust of the exhaust valve, a pressure in the low-vacuum rail high-speed rail vehicle may be regulated, problems of pressure reduction caused by the low-vacuum environment of the high-speed rail vehicle, pressure increase caused by air conditioning intake and ventilation, etc. are solved and the pressure in the high-speed rail vehicle meets safety and health requirements of passengers.

In an embodiment, the air compressor 30 is an electric air compressor, the heat exchanger 31 includes a ram air cooling heat exchanger and a re-cooling heat exchanger, and the ram air inlet 29 includes a ram air forward inlet and a ram air backward inlet.

In an embodiment, the heat exchanger 31 includes: a ram air cooling heat exchanger, where a hot side inlet of the ram air cooling heat exchanger communicates with the air outlet of the air compressor, a hot side outlet of the ram air cooling heat exchanger communicates with the space inside the carriage, a cold side inlet of the ram air cooling heat exchanger communicates with the ram air inlet, and a cold side outlet of the ram air cooling heat exchanger communicates with an outside of the carriage. A temperature of air flows at an outlet of the air compressor is reduced using ram air inside the vacuum rail.

In an embodiment, the rail vehicle further includes: a carriage pressure-regulated re-cooling pipeline, where an air inlet of the carriage pressure-regulated re-cooling pipeline communicates with an inside of the carriage; accordingly, the heat exchanger further includes: a re-cooling heat exchanger, where a hot side inlet of the re-cooling heat exchanger communicates with the hot side outlet of the ram air cooling heat exchanger, a hot side outlet of the re-cooling heat exchanger communicates with the space inside the carriage, a cold side inlet of the re-cooling heat exchanger communicates with an air outlet of the carriage pressure-regulated re-cooling pipeline, and a cold side outlet of the re-cooling heat exchanger communicates with the first end of the exhaust valve. A temperature of air flows at the outlet of the air compressor is reduced by using exhaust re-cooling of the carriage.

In combination with the above two heat exchangers connected in series, the temperature of air flows at the outlet of the air compressor is reduced using ram air inside the vacuum rail, and the temperature of air flows at the outlet of the air compressor is reduced by using exhaust re-cooling of the carriage. A temperature of pressurized air entering the carriage may be appropriate, a heat load of a carriage air conditioning system may be reduced, a size of equipment may be reduced, and energy may be saved.

In an embodiment, the rail vehicle further includes a ram air cooling fan, where an air inlet of the ram air cooling fan communicates with the ram air inlet, and an air outlet of the ram air cooling fan communicates with the cold side inlet of the ram air cooling heat exchanger. Air at the ram air inlet may be branched through the ram air cooling fan.

In an embodiment, the ram air inlet 29 is rotatable to at least forward driving and backward driving directions of the rail vehicle; accordingly, the rail vehicle further includes: a ram air inlet reversing mechanism mechanically connected to the ram air inlet. The ram air inlet reversing mechanism is adopted to make the direction of the ram air inlet 29 adjustable, keep it consistent with a forward direction of the high-speed rail vehicle, and meet air intake requirement of the ram air intake when the high-speed rail vehicle is operating in forward and backward directions.

In an embodiment, the rail vehicle further includes an intra-carriage pressure sensor, where the intra-carriage pressure sensor is communicatively connected to the exhaust valve; and an oxygen generator, where the oxygen generator is communicatively connected to the intra-carriage pressure sensor. By using emergency oxygen supply in the rail vehicle, safety and life-saving problem caused by pressure loss and lack of oxygen in the rail vehicle when a high-speed rail vehicle system containing a low-vacuum rail fails is solved.

The present application further provides a low-vacuum rail vehicle system for operating a rail vehicle, where the low-vacuum rail vehicle system includes: a low-vacuum rail, where the low-vacuum rail is provided with multiple sets of seal doors capable of sealing multiple predetermined sections of the low-vacuum rail, the low-vacuum rail is provided with a pressure recovery air inlet, the pressure recovery air inlet is provided with a pressure recovery intake valve, and the low-vacuum rail is provided with an intra-rail pressure sensor; and a control center, where the control center is communicatively connected to the intra-rail pressure sensor, the seal doors, and the pressure recovery intake valve. The control center monitors a pressure signal of the intra-rail pressure sensor, when a scene where personnel need to be evacuated occurs in the rail vehicle, the control center transmits a door-closing control signal to the seal doors on both sides of a section where the rail vehicle is located, and the control center transmits an intake control signal to the pressure recovery intake valve until the pressure signal reaches a predetermined threshold.

In an embodiment, the low-vacuum rail further includes: a vacuum system exhaust port and a vacuum system; accordingly, the control center is connected to the vacuum system, and the control center transmits a shutdown control signal to the vacuum system when the pressure signal is lower than the predetermined threshold.

In an embodiment, the system further includes: an emergency rescue passage; accordingly, the low-vacuum rail is provided with an emergency rescue door, and the emergency rescue door is used for separating the emergency rescue passage from the low-vacuum rail.

In the present embodiment, by using emergency pressure recovery in the low-vacuum rail, the safety and life-saving problem caused by the loss of pressure in the rail vehicle when a high-speed rail vehicle system containing a low-vacuum rail fails is solved, and passengers may quickly evacuate the low-vacuum rail vehicle system in a safe environment to meet the emergency life-saving requirement of passengers.

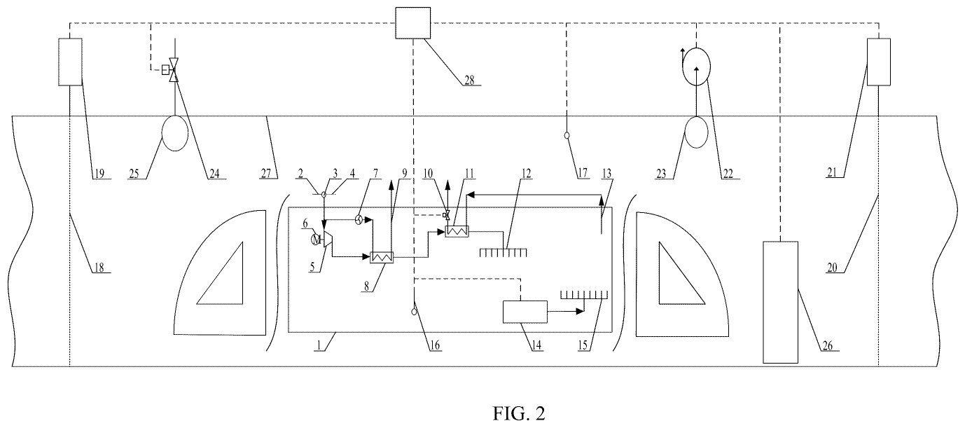

In an embodiment, a high-speed rail vehicle system containing a low-vacuum rail is specifically provided. FIG. 2 is a schematic structural diagram of a high-speed rail vehicle system containing a low-vacuum rail according to an embodiment of the present application. As shown in FIG. 2, when the carriage 1 is operating in the low-vacuum rail 27, the pressure in the carriage 1 is reduced due to low pressure environment in the rail. Therefore, it is necessary to pressurize and regulate the pressure in the carriage 1. A ram air forward inlet 2 is mounted at an upper part of the carriage 1 to introduce low-pressure air in the low-vacuum rail into an electric air compressor 5, and the electric air compressor 5 is driven by a high-speed motor for electric air compressor 6.

After air is compressed by the electric air compressor 5, the pressure of air is slightly higher than a pressure value required by the carriage 1. However, the temperature of air is high and cannot meet temperature requirement of air in the carriage 1. Therefore, cooling is needed. A part of ram air entering from the ram air forward inlet 2 enters a ram air cooling heat exchanger 8 through a ram air cooling fan 7 to cool high-temperature air compressed by the electric air compressor 5. Original ram air used for cooling absorbs heat and heats up in the ram air cooling heat exchanger 8, and then is discharged out of the carriage through a cooling ram air exhaust pipeline 9.

Due to the pressurization demand and ventilation demand of the carriage 1, pressurized air continuously enters the carriage, causing increase in the pressure inside the carriage. Therefore, it is necessary to discharge excess air to meet the pressure control requirement in the carriage 1. A carriage pressure-regulated re-cooling pipeline 13 is mounted inside the carriage 1 and discharges the excess air in the carriage out of the carriage. The temperature of this part of air is still lower than the air compressed by the electric air compressor 5 and cooled by the ram air cooling heat exchanger 8. Therefore, higher-temperature air at the outlet of the ram air cooling heat exchanger 8 may be continuously cooled using lower-temperature air in the re-cooling pipeline 13. This process is a re-cooling process, which is performed in the re-cooling heat exchanger 11. At a hot side of the re-cooling heat exchanger 11, the high-temperature air enters the pressure-regulated air flow distribution pipeline 12 after being cooled, and then is transmitted into the carriage. At a cold side of the re-cooling heat exchanger 11, lower-temperature air in the carriage pressure-regulated re-cooling pipeline 13 is discharged from the exhaust valve 10 out of the carriage after being heated. An opening degree of an exhaust valve 10 is controlled by an intra-carriage pressure sensor 16. Air flow discharged out of the carriage is controlled based on the pressure in the carriage, thereby controlling the pressure in the carriage.

Since the carriage 1 may operate in both directions in the low-vacuum rail 27, that is, there are two directions, forward and backward, and the inlet of the ram air is required to be consistent with the operating direction of the carriage 1. Therefore, a ram air inlet reversing mechanism 3 is mounted below the ram air forward inlet 2. When the carriage 1 operates in the backward direction, the ram air inlet reversing mechanism 3 converts the ram air forward inlet 2 into a ram air backward inlet 4, and the ram air backward inlet 4 may be consistent with the operating direction of the carriage 1.

When emergency situations of carriage 1 such as a failure or loss of pressure, etc. occurs in the low-vacuum rail 27, the pressure drop in the rail vehicle causes the oxygen concentration to drop, which threatens the safety and health of the passengers in the rail vehicle. When the control center 28 finds that a pressure measured by the intra-carriage pressure sensor 16 is lower than a critical dangerous pressure value, the control center 28 controls an oxygen generator 14 inside the carriage 1 to work, and introduce oxygen into an oxygen mask above each passenger through an oxygen mask distribution pipeline 15. Each passenger wears the oxygen mask to breathe oxygen to ensure the oxygen supply for several hours.

When the carriage 1 fails in the low-vacuum rail 27 and the passengers need to evacuate urgently, the intra-carriage pressure sensor 16 and the intra-rail pressure sensor 17 transmit a pressure signal to the control center 28. The carriage 1 stops in the low-vacuum rail 27, and the pressure of the low-vacuum rail section where the carriage 1 is located needs to be recovered. A front seal door 18 and a rear seal door 20 are mounted at intervals in the low-vacuum rail 27. The front seal door 18 and the rear seal door 20 are opened or closed by the front seal door actuator 19 and the rear seal door actuator 21 respectively. Under normal circumstances, both the front seal door 18 and the rear seal door 20 are in an open state. When pressure recovery is required in an emergency, the control center 28 closes the front seal door 18 and the rear seal door 20 based on the position of the low-vacuum rail where the carriage 1 is located. Simultaneously, a vacuum system 22 and a vacuum system exhaust port 23 of this section of the low-vacuum rail are closed, and a pressure recovery air inlet 25 and a pressure recovery intake valve 24 are opened. The pressure recovery air inlet 25 and the pressure recovery intake valve 24 may recover the pressure in this section of the rail to normal atmospheric pressure within a predetermined time. At this time, the doors of the high-speed rail vehicle and the emergency rescue door 26 in the low-vacuum rail are opened, and the passengers in the vehicle evacuate from the low-vacuum rail 27 through a personnel safety passage inside the low-vacuum rail 27. External rescue personnel may also enter the low-vacuum rail 27 through the emergency rescue door 26 for emergency rescue.

It should be noted that embodiments of the present application have better practicability and are not intended to limit the present application in any form. Any technician familiar with the field may use the above disclosed solution to change or modify it into an equivalent effective embodiment. However, any modification or equivalent change and modification made to the above embodiments based on the present application without departing from solution of the present application still falls within the scope of solutions of the present application.

What is claimed is:

1. A railway vehicle, comprising:
a ram air inlet, provided outside a carriage;
an air compressor, wherein an air inlet of the air compressor communicates with the ram air inlet;
a heat exchanger, wherein a hot side inlet of the heat exchanger communicates with an air outlet of the air compressor, a hot side outlet of the heat exchanger communicates with space inside the carriage, and a cold side of the heat exchanger is provided with a refrigerant for heat exchange; and
an exhaust valve, wherein a first end of the exhaust valve is provided at an inner side of the carriage, and a second end of the exhaust valve is provided at an outer side of the carriage.

2. A railway vehicle of claim 1, wherein the heat exchanger comprises:
a ram air cooling heat exchanger, wherein a hot side inlet of the ram air cooling heat exchanger communicates with the air outlet of the air compressor, a hot side outlet of the ram air cooling heat exchanger communicates with the space inside the carriage, a cold side inlet of the ram air cooling heat exchanger communicates with the ram air inlet, and a cold side outlet of the ram air cooling heat exchanger communicates with an outside of the carriage.

3. The railway vehicle of claim 2, further comprising:
a carriage pressure-regulated re-cooling pipeline, wherein an air inlet of the carriage pressure-regulated re-cooling pipeline communicates with an inside of the carriage;
wherein the heat exchanger further comprises:
a re-cooling heat exchanger, wherein a hot side inlet of the re-cooling heat exchanger communicates with the hot side outlet of the ram air cooling heat exchanger, a hot side outlet of the re-cooling heat exchanger communicates with the space inside the carriage, a cold side inlet of the re-cooling heat exchanger communicates with an air outlet of the carriage pressure-regulated re-cooling pipeline, and a cold side outlet of the re-cooling heat exchanger communicates with the first end of the exhaust valve.

4. The railway vehicle of claim 2, further comprising:
a ram air cooling fan, wherein an air inlet of the ram air cooling fan communicates with the ram air inlet, and an air outlet of the ram air cooling fan communicates with the cold side inlet of the ram air cooling heat exchanger.

5. The railway vehicle of claim 1, wherein the ram air inlet is rotatable to at least forward driving and backward driving directions of the rail vehicle;
wherein the rail vehicle further comprises:
a ram air inlet reversing mechanism, wherein the ram air inlet reversing mechanism is mechanically connected to the ram air inlet.

6. The railway vehicle of claim 1, further comprising:
an intra-carriage pressure sensor, wherein the intra-carriage pressure sensor is communicatively connected to the exhaust valve.

7. The railway vehicle of claim 6, further comprising:
an oxygen generator, wherein the oxygen generator is communicatively connected to the intra-carriage pressure sensor.

8. A low-vacuum rail vehicle system, used for operating a rail vehicle,
wherein the rail vehicle comprises:
a ram air inlet, provided outside a carriage;
an air compressor, wherein an air inlet of the air compressor communicates with the ram air inlet;
a heat exchanger, wherein a hot side inlet of the heat exchanger communicates with an air outlet of the air compressor, a hot side outlet of the heat exchanger communicates with space inside the carriage, and a cold side of the heat exchanger is provided with a refrigerant for heat exchange; and
an exhaust valve, wherein a first end of the exhaust valve is provided at an inner side of the carriage, and a second end of the exhaust valve is provided at an outer side of the carriage;
wherein the low-vacuum rail vehicle system comprises:
a low-vacuum rail, wherein the low-vacuum rail is provided with multiple sets of seal doors capable of sealing multiple predetermined sections of the low-vacuum rail, the low-vacuum rail is provided with a pressure recovery air inlet, the pressure recovery air inlet is provided with a pressure recovery intake valve, and the low-vacuum rail is provided with an intra-rail pressure sensor; and
a control center, wherein the control center is communicatively connected to the seal doors, the pressure recovery intake valve, and the intra-rail pressure sensor;
wherein the control center monitors a pressure signal of the intra-rail pressure sensor, when a scene where personnel need to be evacuated occurs in the rail vehicle, the control center transmits a door-closing control signal to the seal doors on both sides of a section where the rail vehicle is located, and the control center transmits an intake control signal to the pressure recovery intake valve until the pressure signal reaches a predetermined threshold.

9. The low-vacuum rail vehicle system of claim 8, wherein the low-vacuum rail further comprises:
a vacuum system exhaust port and a vacuum system;
wherein the control center is connected to the vacuum system, and the control center transmits a shutdown control signal to the vacuum system when the pressure signal is lower than the predetermined threshold.

10. The low-vacuum rail vehicle system of claim 8, further comprising:
an emergency rescue passage;
wherein the low-vacuum rail is provided with an emergency rescue door is provided at, and the emergency rescue door is used for separating the emergency rescue passage from the low-vacuum rail.
